(19) United States
(12) Patent Application Publication
(10) Pub. No.: US 2011/0085210 A1
(43) Pub. Date: Apr. 14, 2011

(54) LIGHTING STRUCTURE AND SCANNING DEVICE

(75) Inventors: Jun Chen, Suzhou (CN); Zhi-Hai Zhang, Suzhou (CN); Yong-Xiang Yi, Suzhou (CN)

(73) Assignee: QISDA (SUZHOU) CO.,LTD, Suzhou (CN)

(21) Appl. No.: 12/887,509

(22) Filed: Sep. 22, 2010

(30) Foreign Application Priority Data
Oct. 9, 2009 (CN) 200910206514.1

(51) Int. Cl. H04N 1/04; F21V 7/22

(52) U.S. Cl. 358/474; 362/613; 362/606; 362/612

(57) ABSTRACT

The invention relates to a lighting structure and a scanning device. The lighting structure comprises a light source and a light guide. The light source comprises a plurality of light emitters spaced within a first plane along a first direction. The light guide comprises a plurality of light guiding bodies arranged in parallel. The light guiding bodies form a one-to-one correspondence with the light emitters and have a light entering surface and a light leaving surface which are both a curved surface. The curve of the intersection between each light leaving surface and a first cross-section has a first curvature radius, and the curve of the intersection between each light entering surface and a second cross-section has a second curvature radius, wherein the first cross-section is perpendicular to the second cross-section, and the first cross-section and the second cross-section are both perpendicular to the first plane.

This application claims the benefit of People's Republic of China application Serial No. 200910206514.1, filed Oct. 9, 2009, the subject matter of which is incorporated herein by reference.

### BACKGROUND OF THE INVENTION

1. Field of the Invention

The invention relates in general to a lighting structure and a scanning device, and more particularly to a lighting structure capable of increasing the utilization rate of the energy of the light and the uniformity of the image for a scanning and imaging system, and a scanning device using the same.

2. Description of the Related Art

The scanning device has been widely used in multi-function machines. Referring to FIG. 1, a schematic view of a conventional scanning device is shown. The scanning device 1 adopts a cold cathode-ray tube lamp (CCFL) or a xenon lamp 10 as a light source, and is combined with a compensation reflector 11 for illuminating a to-be-scanned region 100. The compensation reflector 11 can be divided into a reflection region and an absorption region. The reflection region is used for reflecting the light emitted from the lamp 10 and makes the amount of the reflected light projected onto the document 101, which is placed on a glass substrate 102, as large as possible. The absorption region is used for compensating the non-uniformity of the illumination of the image plane, wherein the non-uniformity of the illumination of the image plane occurs when the illumination decays with the angle of field due to the properties of a lens 12. Afterwards, the light received through a reflecting mirror 14 and the lens 12 is imaged by a line-type image sensor 13. Only the light projected on the to-be-scanned region 100 will be received and imaged by the image sensor 13, therefore the efficiency of the illumination is determined by the ratio of the energy of the partial light projected on the to-be-scanned region 100 to the energy of the total light.

However, the above method still has several disadvantages. For example, accurate shape of the compensation reflector is hard to achieve during assembly, the increase in the utilization rate of the energy of the light is highly restricted, and the energy of the light will be lost due to the absorption of the compensation reflector. Moreover, the CCFL lamp does not match the development trend of green products.

### SUMMARY OF THE INVENTION

To resolve the above technical problems, the invention employs a light emitting diode (LED) as a light source and further adopts a light guide to form a lighting structure of a scanning device for increasing the utilization rate of the energy of the light and the uniformity of the image, and meeting the development trend of green products.

The invention provides a lighting structure used in a scanning device. The lighting structure comprises a light source and a light guide. The light source comprises a plurality of light emitters spaced within a first plane along a first direction. The light guide comprises a plurality of light guiding bodies arranged in parallel. The light guiding bodies form a one-to-one correspondence with the light emitters and have a light entering surface and a light leaving surface, which are both curved surfaces. The curve of the intersection between each light leaving surface and a first cross-section has a first curvature radius, and the curve of the intersection between each light entering surface and a second cross-section has a second curvature radius, wherein the first cross-section is perpendicular to the second cross-section, and the first cross-section and the second cross-section are both perpendicular to the first plane. The light emitted from the light source is uniformly projected on a to-be-scanned object through the light guide.

According to the lighting structure of the invention, each light guiding body is formed by a first cylindrical lens and a second cylindrical lens, the axial line of each first cylindrical lens is parallel to a second direction which is perpendicular to the first direction and parallel to the first plane, and the axial line of each second cylindrical lens is parallel to the first direction.

Further, each first cylindrical lens is a cylindrical concave lens used for diffusing the light emitted from the light source in the first direction, and each second cylindrical lens is a cylindrical convex lens used for focusing the light emitted from the light source in the second direction.

Or, each light entering surface is located on each first cylindrical lens, and each light leaving surface is located on each second cylindrical lens. Or, each light entering surface is located on each second cylindrical lens, and each light leaving surface is located on each first cylindrical lens.

According to the lighting structure of the invention, each light entering surface or each light leaving surface is a curved surface formed by shifting a curve with a third curvature radius along a curve with a fourth curvature radius and is used for diffusing the light emitted from the light source in the first direction and for focusing the light emitted from the light source in the second direction.

According to the lighting structure of the invention, the light guide comprises a first light guiding body and a second light guiding body, and the shape of the curved surface of the first light guiding body is different from that of the second light guiding body.

According to the lighting structure of the invention, the light source comprises a first light emitter and a second light emitter, and the driving current flowing through the first light emitter is greater or smaller than that flowing through the second light emitter.

According to the lighting structure of the invention, the light emitters are spaced by unequal intervals.

According to the lighting structure of the invention, the light emitters are light emitting diodes (LEDs).

The scanning device disclosed in the invention is used for scanning and imaging a to-be-scanned object. The scanning device comprises a lighting structure used for uniformly irradiating the to-be-scanned object.

The invention is capable of increasing the utilization rate of the energy of the light and the uniformity of the image, and meets the development trend of green products.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic view of a conventional scanning device;

FIG. 2 shows a schematic view of a lighting structure according to an embodiment of the invention;

FIG. 3 shows a schematic view of an optical path of a first cross-section according to an embodiment of the invention;

FIG. 4 shows a schematic view of an optical path of a second cross-section according to an embodiment of the invention;

FIG. 5 shows a schematic view of a light guiding body according to another different embodiment of the invention;

FIG. 6 shows a schematic view of a lighting structure according to another embodiment of the invention;

FIG. 7 shows a schematic view of a lighting structure according to another embodiment of the invention; and

FIG. 8 shows a schematic view of a scanning device according to an embodiment of the invention.

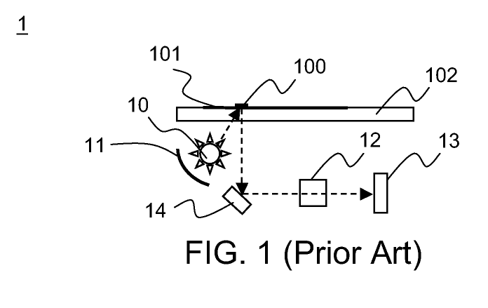

### DETAILED DESCRIPTION OF THE INVENTION

The technologies and their effects adopted in the invention for achieving the above objects are disclosed below in a number of preferred embodiments with accompanying drawings.

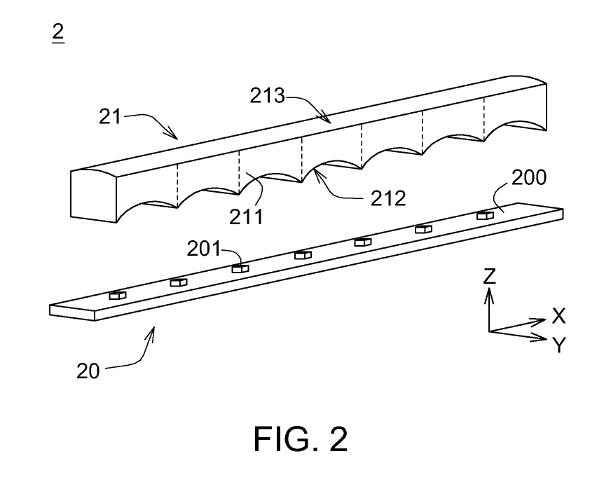

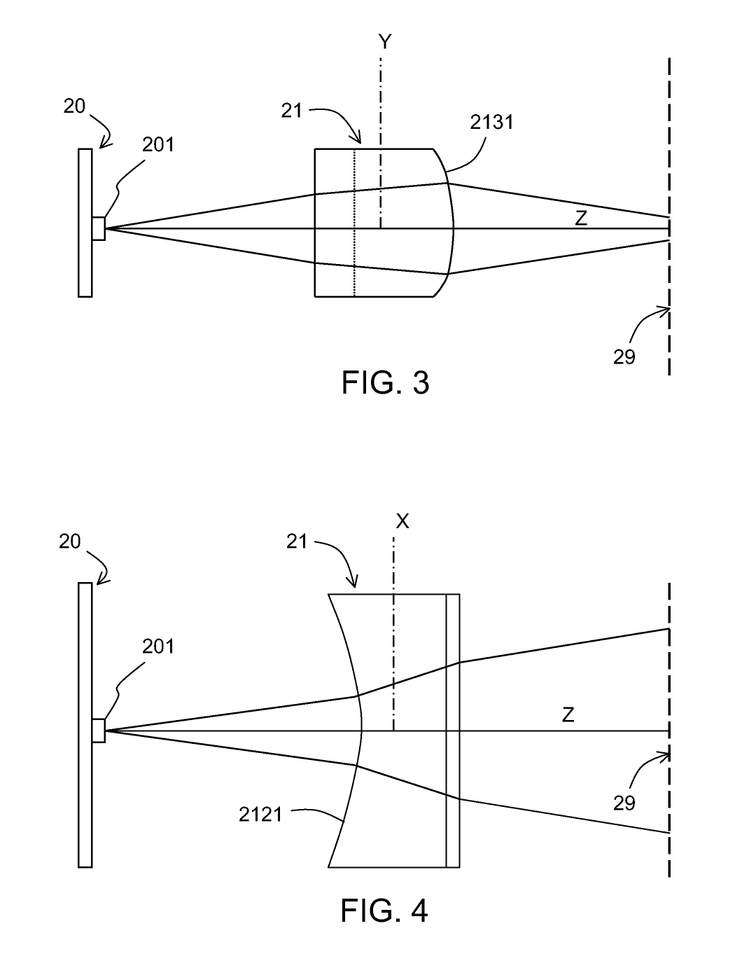

Referring to FIG. 2, a schematic view of a lighting structure 2 according to an embodiment of the invention is shown. The lighting structure 2 used in a scanning device comprises a light source 20 and a light guide 21. The light source 20 comprises a plurality of light emitters 201 spaced within a first plane 200 (parallel to the XY-plane of FIG. 2) along a first direction (parallel to the X direction of FIG. 2). The light guide 21 comprises a plurality of light guiding bodies 211 arranged in parallel. The light guiding bodies 211 form a one-to-one correspondence with the light emitters 201. Each light guiding body 211 has a light entering surface 212 and a light leaving surface 213, which are both curved surfaces. In an embodiment, the light guiding bodies 211 are integrally formed in one piece. That is, all of the light entering surfaces 212 and all of the light leaving surfaces 213 of the light guide 21 are both continuous curved surfaces. Referring to both FIG. 3 and FIG. 4. FIG. 3 shows a schematic view of an optical path of a first cross-section according to an embodiment of the invention. FIG. 4 shows a schematic view of an optical path of a second cross-section according to an embodiment of the invention. The curve 2131 of the intersection between each light entering surface 213 and the first cross-section (parallel to the YZ-plane of FIG. 2) has a first curvature radius, and the curve 2121 of the intersection between each light entering surface 212 and the second cross-section (parallel to the XZ-plane of FIG. 2) has a second curvature radius. The first cross-section is perpendicular to the second cross-section, and the first cross-section and the second cross-section are both perpendicular to the first plane 200. The light emitted from the light source 20 through the light guide 21 is uniformly projected on the to-be-scanned object 29.

In an embodiment, each light guiding body 211 is formed by a first cylindrical lens and a second cylindrical lens, wherein the axial line of each second cylindrical lens is parallel to the second direction (parallel to the Y direction of FIG. 2), the second direction is perpendicular to the first direction and parallel to the first plane 200, and the axial line of each second cylindrical lens is parallel to the first direction. In practical application, the first cylindrical lens realized by a cylindrical concave lens is used for diffusing the light emitted from the light source in a first direction as indicated in FIG. 4, so that the light is re-distributed according to the distribution of the array of the light emitters and the relationship between the relative illumination of the image plane and the angle of field. The second cylindrical lens realized by a cylindrical convex lens is used for focusing the light emitted from the light source in a second direction as indicated in FIG. 3 for increasing the utilization rate of the energy of the light.

According to the principle of reversibility of optical path, each light entering surface 212 and each light leaving surface 213 are exchangeable to each other. That is, each light entering surface 212 can be located on each first cylindrical lens, and each light leaving surface 213 can be located on each second cylindrical lens. Or, each light entering surface 212 can be located on each second cylindrical lens, and each light leaving surface 213 can be located on each first cylindrical lens. The structure of each light guiding body 211 of the invention is not limited thereto.

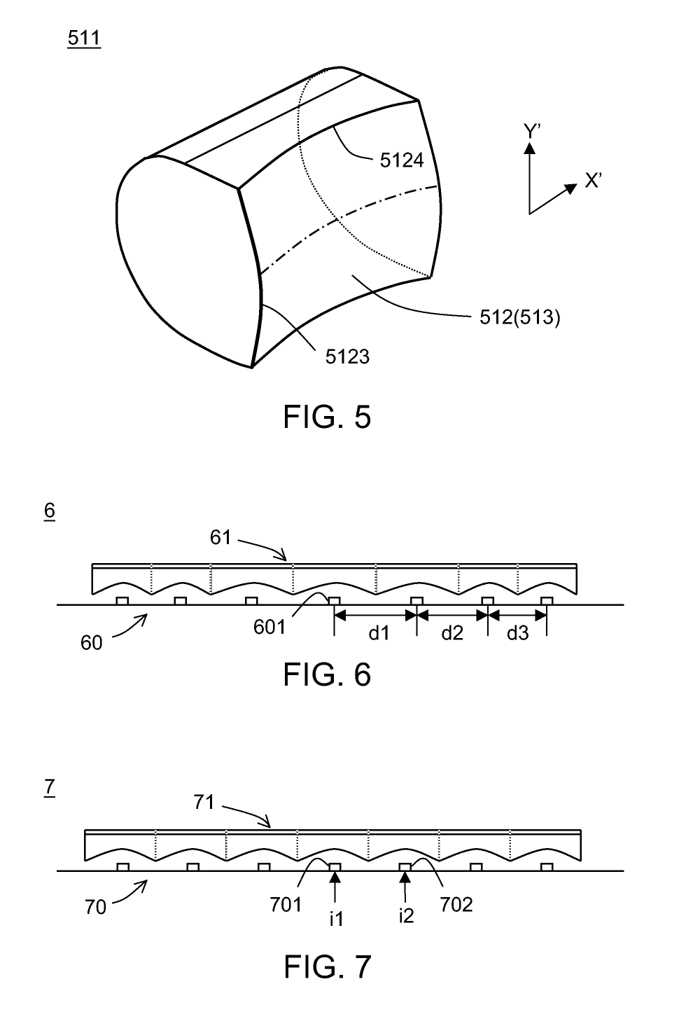

Referring to FIG. 5, a schematic view of a light guiding body 511 according to a different embodiment of the invention is shown. The light guiding body 511 is different from the said light guiding body 211 in that a light entering surface 512 is a curved surface formed by shifting a curve 5123 with a third curvature radius along a curve 5124 with a fourth curvature radius and is used for diffusing the light emitted from the light source in the X′ direction and focusing the light emitted from the light source in the Y′ direction. Likewise, the said curved surface, which can also be used as a light leaving surface 513, not only focuses the light in a direction for increasing the utilization rate of the energy of the light but also diffuses the light in another direction for increasing the uniformity, hence reducing the necessary number of the light emitters.

It is noted that the shapes of the light guiding bodies located in different positions can be the same or different as long as the distribution of the light intensity of the to-be-scanned region meets predetermined standards. In an embodiment, the light guide comprises a first light guiding body and a second light guiding body, wherein the shape of the curved surface of the first light guiding body is different from that of the second light guiding body. In practical application, the design of the shape of the curved surface is based on the parameters such as the index of refraction the light guide, the distance from each light leaving surface to the to-be-scanned object, and the distance from the light source to each light entering surface, and optical formulas.

Besides, the light emitters of the invention can be spaced by equal or unequal intervals as long as the distribution of the light intensity of the to-be-scanned region meets predetermined standards. Referring to FIG. 6, a schematic view of a lighting structure 6 according to another embodiment of the invention is shown. The lighting structure 6 comprises a light source 60 and a light guide 61. The light source 60 comprises a plurality of light emitters 601 spaced by unequal intervals (such as d1, d2 and d3), and the similarities with the above embodiments are not repeated here.

Furthermore, the currents of the light emitters located in different positions can be the same or different as long as the distribution of the light intensity of the to-be-scanned region meets predetermined standards. Referring to FIG. 7, a schematic view of a lighting structure 7 according to yet another embodiment of the invention is shown. The lighting structure 7 comprises a light source 70 and a light guide 71. The light source 70 comprises a first light emitter 701 and a second light emitter 702. The driving current i1 flowing through the first light emitter 701 is greater or smaller than the driving current i2 flowing through the second light emitter 702. Other similarities with the above embodiments are not repeated here. The combination of the above implementations can compensate the relationship between the relative illumination of image plane and the angle of field for increasing the uniformity of the image plane.

In practical application, the light emitters of the invention can be realized by light emitting diodes (LEDs) or other types of point light source, and the invention is not limited thereto.

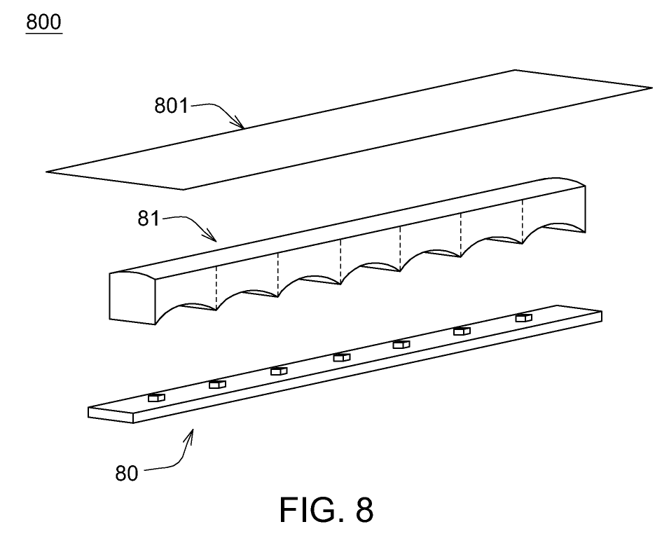

Referring to FIG. 8, a schematic view of the scanning device 800 according to an embodiment of the invention is shown. The scanning device 800 is used for scanning and imaging a to-be-scanned object 801, which comprises a lighting structure. The lighting structure comprises a light source 80 and a light guide 81 for uniformly irradiating the to-be-scanned object 801. The lighting source 80 and the light guide 81 can have the same structure as in the above embodiments. In practical application, the to-be-scanned object 801 is generally disposed on a transparent substrate, and the light guide 81 is placed between the light source 80 and the transparent substrate. Other elements of the scanning device 800 such as linear image sensor and lens are not within the scope of the technical features of the invention, and are not repeated here.

The invention is capable of increasing the utilization rate of the energy of the light and the uniformity of the image, and meets the development trend of green products. Moreover, the lighting structure of the invention is particularly applicable to the scanning device.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting structure, used in a scanning device, comprising a light source and a light guide, wherein
the light source comprises a plurality of light emitters spaced within a first plane along a first direction;
the light guide comprises a plurality of light guiding bodies arranged in parallel, the light guiding bodies form a one-to-one correspondence with the light emitters, each light guiding body have a light entering surface and a light leaving surface which are both curved surfaces, the curve of the intersection between each light leaving surface and a first cross-section has a first curvature radius, the curve of the intersection between each light entering surface and a second cross-section has a second curvature radius, the first cross-section is perpendicular to the second cross-section, the first cross-section and the second cross-section are both perpendicular to the first plane; and
the light emitted from the light source is uniformly projected on a to-be-scanned object through the light guide.

2. The lighting structure according to claim 1, wherein each light guiding body is formed by a first cylindrical lens and a second cylindrical lens, the axial line of each first cylindrical lens is parallel to a second direction perpendicular to the first direction and parallel to the first plane, and the axial line of each second cylindrical lens is parallel to the first direction.

3. The lighting structure according to claim 2, wherein each first cylindrical lens is a cylindrical concave lens used for diffusing the light emitted from the light source in the first direction, and each second cylindrical lens is a cylindrical convex lens used for focusing the light emitted from the light source in the second direction.

4. The lighting structure according to claim 2, wherein each light entering surface is located on each first cylindrical lens, and each light leaving surface is located on each second cylindrical lens; or, each light entering surface is located on each second cylindrical lens, and each light leaving surface is located on each first cylindrical lens.

5. The lighting structure according to claim 1, wherein each light entering surface or each light leaving surface is a curved surface formed by shifting a curve with a third curvature radius along a curve with a fourth curvature radius and is used for diffusing the light emitted from the light source in the first direction and for focusing the light emitted from the light source in the second direction.

6. The lighting structure according to claim 1, wherein the light guide comprises a first light guiding body and a second light guiding body, and the shape of the curved surface of the first light guiding body is different from that of the second light guiding body.

7. The lighting structure according to claim 1, wherein the light source comprises a first light emitter and a second light emitter, and the driving current flowing through the first light emitter is greater or smaller than the driving current flowing through the second light emitter.

8. The lighting structure according to claim 1, wherein the light emitters are spaced by unequal intervals.

9. The lighting structure according to claim 1, wherein the light emitters are light emitting diodes (LEDs).

10. A scanning device used for scanning and imaging a to-be-scanned object, wherein the scanning device comprises:
a lighting structure, used in the scanning device, comprising a light source and a light guide, wherein
the light source comprises a plurality of light emitters spaced within a first plane along a first direction;
the light guide comprises a plurality of light guiding bodies arranged in parallel, the light guiding bodies form a one-to-one correspondence with the light emitters, each light guiding body have a light entering surface and a light leaving surface which are both curved surfaces, the curve of the intersection between each light leaving surface and a first cross-section has a first curvature radius, the curve of the intersection between each light entering surface and a second cross-section has a second curvature radius, the first cross-section is perpendicular to the second cross-section, the first cross-section and the second cross-section are both perpendicular to the first plane; and
the light emitted from the light source is uniformly projected on a to-be-scanned object through the light guide.

11. The scanning device according to claim 10, wherein each light guiding body is formed by a first cylindrical lens and a second cylindrical lens, the axial line of each first cylindrical lens is parallel to a second direction perpendicular to the first direction and parallel to the first plane, and the axial line of each second cylindrical lens is parallel to the first direction.

12. The scanning device according to claim 11, wherein each first cylindrical lens is a cylindrical concave lens used for diffusing the light emitted from the light source in the first direction, and each second cylindrical lens is a cylindrical convex lens used for focusing the light emitted from the light source in the second direction.

13. The scanning device according to claim 11, wherein each light entering surface is located on each first cylindrical lens, and each light leaving surface is located on each second cylindrical lens; or, each light entering surface is located on each second cylindrical lens, and each light leaving surface is located on each first cylindrical lens.

14. The scanning device according to claim 10, wherein each light entering surface or each light leaving surface is a curved surface formed by shifting a curve with a third curvature radius along a curve with a fourth curvature radius and is used for diffusing the light emitted from the light source in the first direction and for focusing the light emitted from the light source in the second direction.

15. The scanning device according to claim 10, wherein the light guide comprises a first light guiding body and a second light guiding body, and the shape of the curved surface of the first light guiding body is different from that of the second light guiding body.

16. The scanning device according to claim 10, wherein the light source comprises a first light emitter and a second light emitter, and the driving current flowing through the first light emitter is greater or smaller than the driving current flowing through the second light emitter.

17. The scanning device according to claim 10, wherein the light emitters are spaced by unequal intervals.

18. The scanning device according to claim 10, wherein the light emitters are light emitting diodes (LEDs).
